(19) United States
(12) Patent Application Publication
(10) Pub. No.: US 2013/0008848 A1
(43) Pub. Date: Jan. 10, 2013

(54) FILTER COMPRISING STACKABLE FILTER WAFERS WITH FILTERING CHANNELS ON OPPOSING SIDES OF THE WAFERS

(75) Inventors: Kerstin Jonsson, Uppsala (SE); Maria Bendixen, Uppsala (SE); Håkan Johansson, Uppsala (SE); Tor-Arne Grönland, Sollentuna (SE)

(73) Assignee: NANOSPACE AB, Uppsala (SE)

(21) Appl. No.: 13/637,231

(22) PCT Filed: Apr. 4, 2011
(86) PCT No.: PCT/SE11/50392

§ 371 Date: Sep. 25, 2012

(30) Foreign Application Priority Data
Apr. 14, 2010 (SE) 1050366-2

(51) Int. Cl. B01D 29/46; B01D 29/58

(52) U.S. Cl. 210/488

(57) ABSTRACT

A filter comprises a stack of wafers (28). Each of the wafers has a through hole (6). Edges (7) of the holes together define an internal tube. An interface (32) between adjacent wafers defines filter channels. The filter channels comprises first coarse filter channels (20), second coarse filter channels (22) and fine filter channels (26). The first coarse filter channels are open towards an outer rim (5), extend in a direction from the outer rim and are closed towards the internal tube. The second coarse filter channels are arranged in an opposite manner. The fine filter channels connect the first and second coarse filter channels. The first and second coarse filter channels extend radially (R) and the fine filter channels extend tangentially (T). The first and second coarse filter channels are defined by recesses in a surface of a first wafer and the fine filter channels are defined by recesses, each one encircling the hole, in a surface of a second wafer.

### TECHNICAL FIELD

The present invention relates in general to fluid filters and in particular to fluid filters having a plurality of filter channels.

### BACKGROUND

Flows of fluids, i.e. gas and/or liquids, are used in many types of applications. Non-exclusive examples are supply flows for chemical processes, as transport medium, for pneumatic operations or for propelling action. In common for many applications is that there is a request for a particle-free fluid stream, e.g. for avoiding damages of components or clogging of flow conducts. Particle-free fluid flows can be achieved by employing different kinds of filtering.

The introduction of a filter always results in a certain degree of pressure drop over the filter. In many applications, it is important to have as low pressure drop over the filter as possible. The pressure drop depends on a lot of factors, such as total filter channel cross-section area, filter channel length, filter channel shape, filter channel curvature etc.

A fluid filter can also be characterised by the largest particle size that is allowed to pass the filter. A common design for fine filters is to provide a multitude of parallel narrow filter channels. The maximum size of particles being able to pass the filter is essentially defined by the filter channel area. The pressure drop and total flow rate mainly are determined by factors such as the filter channel lengths and total flow cross-section, i.e. essentially the filter channel area times the number of filter channels, as well as the filter channel area. Since the demands of maximum particle size and total flow rate/pressure drop typically strive in different directions, some compromises have to be done.

Etched discs have been used for some time to form fluid filters. In the traditional approach, a thin circular foil is etched on at least one side to provide paths projecting in a radial direction from the internal diameter to the external diameter. The disks are stacked on top of each other in a cylindrical column until a required total flow rate can be achieved. A problem with such approaches is that when the filter channel cross-section is made small for a high filtering effect, the pressure drop becomes higher, and in order to reduce the pressure drop, the radial length of the filter channels has to be shortened until only a very thin disc circle remains, which is difficult to mount and handle and which is mechanically unstable.

In the European patent No. 1 031 734, an assembly of etched sheets forming a fluidic module is disclosed. A number of parallel flow channels are provided through thin discs. Each flow channel has its own flow control system and the total flow rate depends on the number of channels through each disc. The functionality is provided in a modular fashion where each disc provides a particular function.

The U.S. Pat. No. 6,510,948 discloses a multiple radial arm etched disc filter element. The etched discs have an overall shape that is circular and have filtering arms which radially extend from the centre of each disc to the exterior border of the disc. The filtering arms separate inlet and outlet openings extended in an axial fashion along the stacked filter arms. However, in order to provide short filter channels to reduce the pressure drop over the filter, the arms have to be extremely thin, which puts severe restrictions to alignment as well as mechanical strength.

The U.S. Pat. No. 5,711,877 discloses etched discs with crosshatch patterns. The crossover pattern of flow passages are spiralling out in opposite directions from the inner to the outer diameter of the disc. The channels have a depth slightly greater than half the disc thickness which means that openings are formed through the thickness of the disc. The design has a low flow loss. However, the limitation of the smallest filter channel is set by half the disc thickness. However, for extremely small filter channels, the disc thickness has to be so small that mounting and stability of the discs are lost.

The patent GB 1,096,739 discloses a fluid filter formed by a stack of plates. I each plate, closed radial grooves are provided, from a centre opening as well as from a periphery of the plate. These grooves are connected by a number of smaller grooves directed in tangential direction. When the grooves are held against a opposing flat surface, coarse filter channels connected by a number of fine filter channels are defined.

The patent U.S. Pat. No. 4,661,250 also discloses a filter built by stacking plates. In this disclosure, the coarse filter channels are connected by a slit extending radially over the main part of the plate. The slit operates as a fine filter for particles having small aspect ratios. However, fibrous particles may still escape through the narrow slit.

The patent GB 837,627 discloses a filter, where entrance and exit channels are provided by electrolytic etching. To this end, protection layers are used during the manufacturing procedures, but are removed before the final mounting.

The published patent application US2008/0272068 discloses a filter arrangement based on grooves in a plate. Coarse channels are provided in a slightly curved form in order to increase the total length of the coarse channels. Fine channels are then provided straight through the walls for connecting the coarse channels.

The U.S. Pat. No. 2,592,104 discloses a filter element where alternative filter channel arrangements are provided radially inside and outside of each other. A fluid is filtered by either one, since the part filters are arranged in a parallel fashion, with respect to the streaming, and the arrangement thereby increases the total flow rate.

The U.S. Pat. No. 4,686,038 discloses a filter arrangement with a housing separating a volume being in contact with the outer rime of a number of filter plates and a volume being in contact with an inner edge of the filter plates.

Common for many of the above mentioned filter arrangements is that they comprise relatively complex surface structures. However, such disclosed surface structures become difficult to manufacture when extremely narrow filter channels are requested.

A general problem with prior art filter designs is that there is a problem to provide reliable, mechanically rigid, easily mountable, scalable filters with a very small filter channel size that at the same time provide low pressure drops.

### SUMMARY

A general object of the present invention is to provide fluid filter designs which allows for extremely small and well defined filter channels, that is easily scalable and mounted and which provides a low pressure drop over the filter. The object is achieved by filters according to the independent claim. Preferred embodiments are described by the dependent claims. In general words, in a first aspect, a filter comprises a stack of wafers. Each of the wafers has a through hole. Edges of the holes of the wafers in the stack together define an internal tube. At least one interface between adjacent wafers defines an arrangement of filter channels. The arrangement of filter channels comprises first coarse filter channels, second coarse filter channels and fine filter channels. The first coarse filter channels are open towards an outer rim of the stack of wafers, extend in a direction from the outer rim towards the internal tube and are closed towards the internal tube. The second coarse filter channels are open towards the internal tube, extend in a direction from the internal tube towards the outer rim of the stack of wafers and are closed towards the outer rim of the stack of wafers. The fine filter channels connect the first coarse filter channels and the second coarse filter channels. The first coarse filter channels and the second coarse filter channels extend substantially radially with respect to the hole. The fine filter channels extend substantially tangentially with respect to the hole. The first coarse filter channels and the second coarse filter channels are defined by recesses in a surface of a first wafer defining the interface and the fine filter channels are defined by recesses in a surface of a second wafer, opposite to the first wafer, defining the interface. The recesses in the surface of the second wafer defining the fine filter channels are continuous recesses, each one encircling the hole.

In a second aspect, a filter assembly comprises a filter housing, a filter according to the first aspect arranged in the filter housing, and a sealing, separating a volume being in contact with the outer rim of the stack of wafers from a volume being in contact with the internal tube.

One advantage with the present invention is that small filter channel sizes are combined with a low pressure drop in a design that is easily scalable and easily mountable. Further advantages are described in connection with the embodiments of the detailed description.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a prior art filter disc;

FIG. 2A is a schematic illustration of an embodiment of a filter wafer according to the present invention;

FIG. 2B is a part of a cross-section view of an embodiment of a filter stack according to the present invention;

FIG. 2C is a part of a cross-section view of another embodiment of a filter stack according to the present invention;

FIG. 3 is a cross-section view of an embodiment of a filter assembly according to the present invention;

FIGS. 4A-C are schematic illustrations of different embodiments of filter wafers according to the present invention;

FIG. 5 is a schematic illustration of an embodiment of a filter wafer according to the present invention providing a tandem filtering; and

FIG. 6 is a cross-section view of another embodiment of a filter assembly according to the present invention providing tandem filtering.

### DETAILED DESCRIPTION

Throughout the drawings, the same reference numbers are used for similar or corresponding elements.

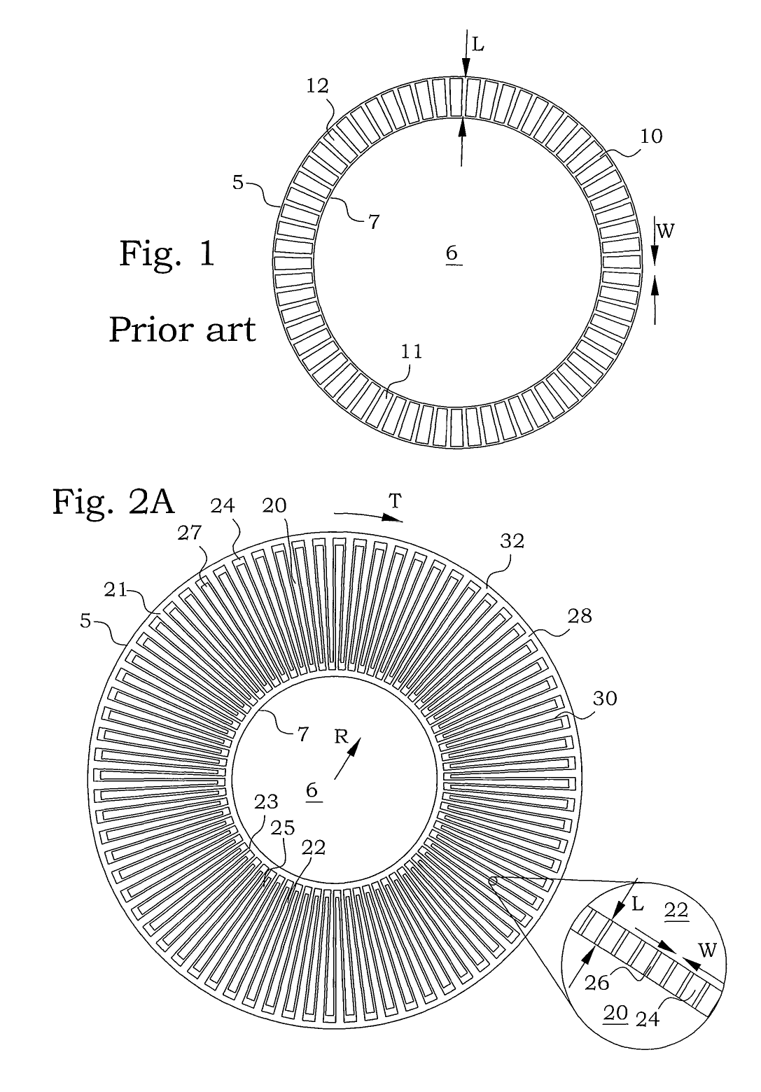

In a prior art fluid filters based on etched discs, an example of which is schematically illustrated in FIG. 1, provides in an interface of a disc 12 a number N of filter channels 10. The filter channels 10 are thus separated by ridges 11. The channels 10 extend between an outer rim 5 of the disc 12 and an edge 7 of a hole 6 in the middle of the disc 12. The tangential distance between two ridges 11 defines the width W of the filter channels 10 and the distance between the outer rim 5 and the edge 7 of the hole 6 defines the length L of the filter channels 10. If a fine filter is requested, where the size of the particles that are allowed to pass the filter is very small, the width W has to be small. A small filter channel width W at the same time gives rise to a large pressure drop and a reduced overall flow rate through the filter channels 10. In order to compensate for such disadvantages, the length L of the filter channels 10 can instead be reduced and the number N of filter channels 10 can be increased. However, when the length L of the filter channels 10 is reduced too much, the mechanical rigidity of the disc 12 decreases since only a very narrow annulus will remain. At the same time, when the distance L between the outer rim 5 and the edge 7 of the hole 6 becomes small, most of the disc material and in particular of the disc surface is wasted and a relatively large unused central hole is created.

In filters according to the present invention, the disc material and in particular of the disc surface is used in a much more efficient manner, which opens up for creation of extremely fine filters, still with acceptable pressure drops and flow rates. By distributing the fine filter channels over a larger area of the disc, by using coarse feeding and draining channels, the fine filter channels can be made extremely short and also be provided in a very huge number. These basic principles will be demonstrated by use of a number of embodiments here below.

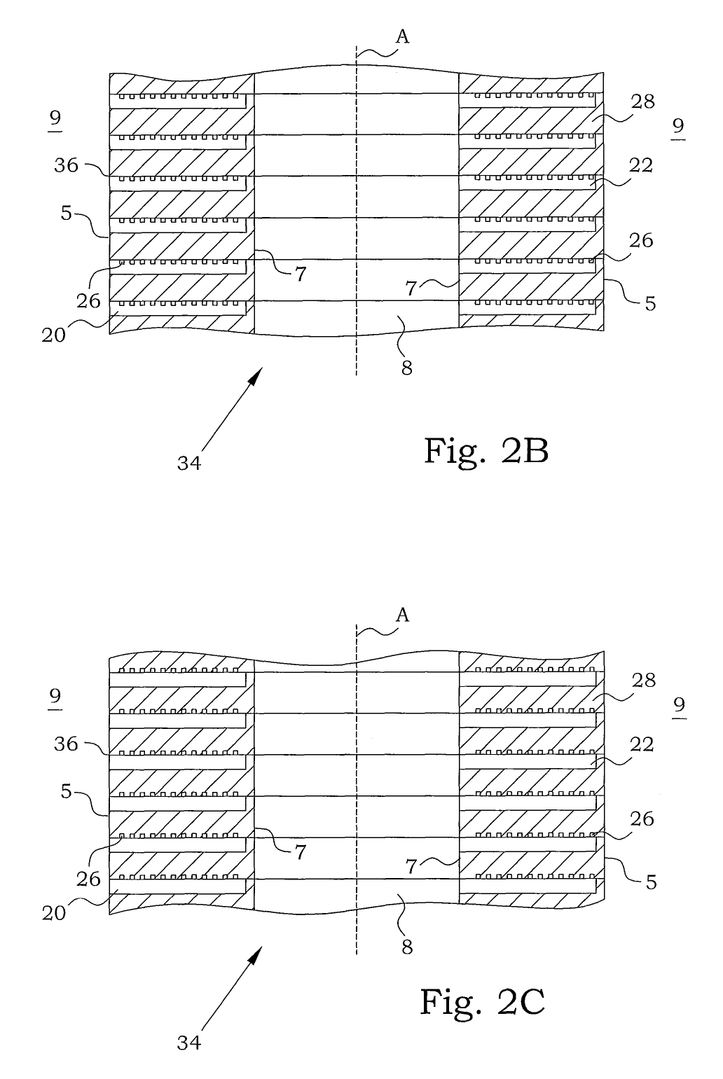

FIG. 2A illustrates a wafer 28, in this embodiment a circular wafer, with a surface having grooves contributing to the forming of an arrangement of filter channels 30. The wafer 28 is intended to be stacked against other wafers and thereby together form the arrangement of filter channels 30 in the interface between two wafers. FIG. 1 can therefore been seen as a cross-sectional view of a stack of wafers taken at the interface 32 between two wafers 28. In the present embodiment, the wafer 28 is a silicon wafer with etched grooves produced by conventional MEMS (MicroElectroMechanical System) techniques. However, other materials and process methods for producing the wafers are also possible to use.

The wafer 28 has through hole 6 with an edge 7. In the present embodiment, the hole 6 is centred at the centre of the wafer 28, but in other embodiments, other geometrical conditions may be used. The arrangement of filter channels 30 comprises a number of first coarse filter channels 20, second coarse filter channels 22, and fine filter channels 26 (as seen in the enlarged portion). In the particular illustrated embodiment, the first coarse filter channels 20 are intended as supply filter channels or inlet filter channels, while the second coarse filter channels 22 are intended as drain filter channels or outlet filter channels. However, in alternative embodiments, the situation may be the opposite, i.e. that the second coarse filter channels 22 are intended as supply filter channels or inlet filter channels, while the first coarse filter channels 20 are intended as drain filter channels or outlet filter channels. The first coarse filter channels 20 are open towards an outer rim 5 of the wafer 28. The first coarse filter channels 20 may have this open end 21 very close to the outer rim 5, as in the present embodiment, or alternatively at a certain distance from the outer rim 5. The first coarse filter channels 20 extend in a direction from the outer rim 5 towards the edge 7 of the hole 6. The first coarse filter channels 20 are closed towards the edge 7 of the hole 6. The first coarse filter channels 20 may have this closed end 25 very close to the edge 7, as in the present embodiment, or alternatively at a certain distance from the edge 7. The first coarse filter channels 20 may, as in the present embodiment, have the same shape. However, in alternative embodiments, the shapes may vary between different individual first coarse filter channels 20.

Analogously, the second coarse filter channels 22 are open towards the edge 7 of the hole 6. The second coarse filter channels 22 may have this open end 23 very close to the edge 7, as in the present embodiment, or alternatively at a certain distance from the edge 7. The second coarse filter channels 22 extend in a direction from the edge 7 towards the outer rim 5 of the wafer 28. The second coarse filter channels 22 are closed towards the outer rim 5. The second coarse filter channels 22 may have this closed end 27 very close to the outer rim 5, as in the present embodiment, or alternatively at a certain distance from the outer rim 5. The second coarse filter channels 22 may, as in the present embodiment, have the same shape. However, in alternative embodiments, the shapes may vary between different individual second coarse filter channels 22.

In the present embodiment, the first coarse filter channels 20 and the second coarse filter channels 22 are interleaved with each other in a tangential direction T. This interleaving creates a narrow ridge 24 between the first coarse filter channels 20 and the second coarse filter channels 22. This ridge 24 has in the present embodiment a meandering shape between the outer rim 5 and the edge 7. The total length of the ridge 24 thereby becomes much larger than any straight distances between any two points on the wafer 28. By locating the first coarse filter channels 20 and the second coarse filter channels 22 very close to each other, the ridge 24 becomes narrow. A part of the wafer 28 is illustrated in an enlarged version in FIG. 2, showing a part of the ridge 24, with a first coarse filter channel 20 on one side and a second coarse filter channel 22 on the other side. Through the ridge 24, fine filter channels 26 are formed. The fine filter channels 26 thereby connect the first coarse filter channel 20 and the second coarse filter channel 22. Due to the narrow ridge 24, the fine filter channels 26 are relatively short, which ensures a low pressure drop. At the same time, since the total length of the meandering ridge 24 is very long, a very large number of fine filter channels 26 may be provided over the ridge 24. A fluid flow from a volume outside the rim 5 to a volume inside the edge 7 has to flow through one of the first coarse filter channels 20, through one of the fine filter channels 26 and out through one of the second coarse filter channels 22. The quality of the filter, i.e. the largest particle size that is allowed to pass the filter is defined by the cross-sectional area of the fine filter channels 26.

In the present embodiment, each of the filter channels in the arrangement of filter channels 30 are closed in a direction transverse to a main plane of the wafer 28, i.e. the central hole 6 is the only opening through the wafer 28. However, in alternative embodiments, there might also be openings through the wafer within the filter channel arrangement 30. In order to assure that there are no flow paths that do not pass the fine filter channels 30 such embodiments typically involve careful aligning of neighbouring wafers.

Each of the first coarse filter channels 20 and the second coarse filter channels 22 has preferably a cross-section area that is large enough to accommodate the flow to or from the fine filter channels 26. In other words, the cross-section area is larger than the sum of the cross-section areas of fine filter channels 26 connecting the respective first coarse filter channel 20 or second coarse filter channel 22. In such a way, it is assured that neither the first coarse filter channel 20 nor the second coarse filter channel 22 will limit the flow through the filter. This also means that the pressure drop over the first coarse filter channel 20 and the second coarse filter channel 22 is small compared to the pressure drop over the fine filter channel 26. The pressure drop over the entire filter will therefore be determined mainly by the length and diameter of the fine filter channels 26. Since the ridge 24 can be made very thin, the length of each fine filter channel 26 can be extremely short compared to what is achievable in prior art filters.

In the present embodiment, the fine filter channels 26 are straight channels through the ridge 24 with a square cross-section. However, in alternative embodiments, the fine filter channels 26 may be curved. Such a design, prohibiting a line of sight between adjacent first coarse filter channels 20 and second coarse filter channels 22, will typically increase the filtering efficiency against fibrous materials or other particles having an elongated shape.

The fine filter channels may also have other types of cross-sectional shape. A cross-section with edges, e.g. square or star shaped cross-sections can be efficient for filtering round particles. A round particle will typically be stopped by the smallest distance across the cross-section of the fine filter channels. A square or star shape will provide a large total area while still having a small “smallest distance”. Cross-sections with round shapes can be more efficient for more complex shaped particles. A complex shaped particle may be turned to pass its largest dimensions though the largest cross-section distance of the filter cross-section. The most efficient filter shape should in such cases have a high ratio between the cross-section area and the largest diameter, which corresponds to a circular filter cross-section shape. In the present embodiment, the fine filter channels are almost identical. However, in other embodiments, different types of fine filter channels may be used in parallel.

In the present embodiment, the wafers 28 are made from silicon wafers with a thickness of 300 μm with an outer diameter of the rim of 12 mm and an inner diameter of the edge of 5 mm. There are 72 first coarse filter channels 20 and 72 second coarse filter channels 22 and more than 18 000 fine filter channels of 10×10 μm cross-section. However, wafer sizes, number of channels, minimum channel size etc. are easily modified in order to suit the intended application. Filters down to 0.1 μm fine filter channel diameters are easily manufactured according to the above principles.

As mentioned above, the arrangement of filter channels 30 is defined at an interface between adjacent wafers. FIG. 2B illustrates a part of a stack 34 of wafers in cross-section along the axis A of the stack. The stack 34 of wafers together forms a filter 40. Note that the dimensions, in particular in the vertical direction, of the different structures are NOT drawn in scale, in order to be able to visualize the principles of the structures. An interface 36 is formed between each pair of adjacent wafer 28, defining an arrangement of filter channels 30. The edges 7 of the holes of the 28 wafers in the stack 34 together defines an internal tube 8. In this stack 34, each wafer 28 has a surface structure, e.g. according to FIG. 2A, etched into the wafer 28 surface. In this example, the first coarse filter channels 20, the second coarse filter channels 22 and the fine filter channels 26 are all defined by recesses in a same surface of a first wafer defining the interface. (The channel sizes are exaggerated, in particular for the fine filter channels, in order to increase the understanding of the figure.) The opposite wafer of the interface is typically planar. The same condition is repeated for each wafer 28. In other words, in the present embodiment, the wafers 28 are etched only at one side and are planar on the opposite side to close the filter channels of a neighbouring wafer. The topmost wafer (not shown) is typically a totally plane wafer. This is similar to ideas of prior art approaches. However, as mentioned, the relatively complex mechanical structures that has to be provided, may be difficult to manufacture, in particular for extremely narrow channels.

Other similar configurations may also be used. A wafer may e.g. be etched with channels on both sides and stacked in an interleaved manner with planar wafers.

However, an embodiment solving such problems is illustrated in FIG. 2C. Here each wafer in the stack 34 has first coarse filter channels 20 and second coarse filter channels 22 etched into the surface of one side of the wafer, and fine filter channels 26 etched into the surface of the opposite side of the wafer. By stacking such wafers onto each other, interfaces will be formed in which an arrangement of filter channels 30 is defined. In other words, the first coarse filter channels 20 and the second coarse filter channels 22 are defined by recesses in a surface of a first wafer 28 defining an interface 36 and the fine filter channels 26 are defined by recesses in a surface of a second wafer 28, opposite to the first wafer, defining the interface 36. Since the complexity of the pattern on each surface is reduced, the manufacturing is considerably simplified.

However, the two-side configuration also gives rise to new aspects to consider. Since the filtering action is dependent on the interaction between structures in two surfaces facing each other, it is an advantage if the structures are configured in such a way that the relative alignment between the wafers becomes of low importance. Most preferably is if e.g. the relative rotational alignment is of no importance at all. In the present embodiment the first coarse filter channels 20 and second coarse filter channels 22 extend substantially radially with respect to the hole 6. Simultaneously, the fine filter channels 26 extend substantially tangentially with respect to the hole 6. By having fine filter channel structures in one surface that are considerably longer than the width of the corresponding ridges 24 a certain misalignment in rotation can be accepted. In a particular embodiment, the fine filter channels 26 are continuous channels encircling the hole. In such a case, no rotational alignment at all between adjacent wafers is necessary.

A fluid flow from a volume 9 outside the rim 5 of the wafers 28 to the internal tube 8 has to flow through the arrangement of filter channels 30 of one of the interfaces 36. The total flow rate can easily be increased by increasing the number of interfaces, i.e. to stack more wafers 28 on top of each other. However, in order not to limit the total flow by the size of the internal tube, the internal tube 8 preferably has a cross-section area that is larger than the sum of the cross-section areas of the second coarse filter channels 22. The stack 34 of wafers constitutes a filter 40, which is easily scalable and therefore can be adapted to different conditions.

The structures forming the filter channels are provided in the surface of the wafers. In the present embodiment, the structures are provided by MEMS techniques directly in the wafer surface of a silicon wafer. The precision in MEMS structures is extremely high, which makes it possible to assure almost perfect filter channels, e.g. in terms of dimensions and shapes. However, other solutions are also easily applicable. The wafers may e.g. be coated by a coating, such as e.g. SiO₂, Si₃N₄ or Au, in which the structures are provided. Such a structuring could be performed either after the coating or concurrently with the coating. Similarly, the surface can be treated in other ways before, at the same time as and/or after providing the structures.

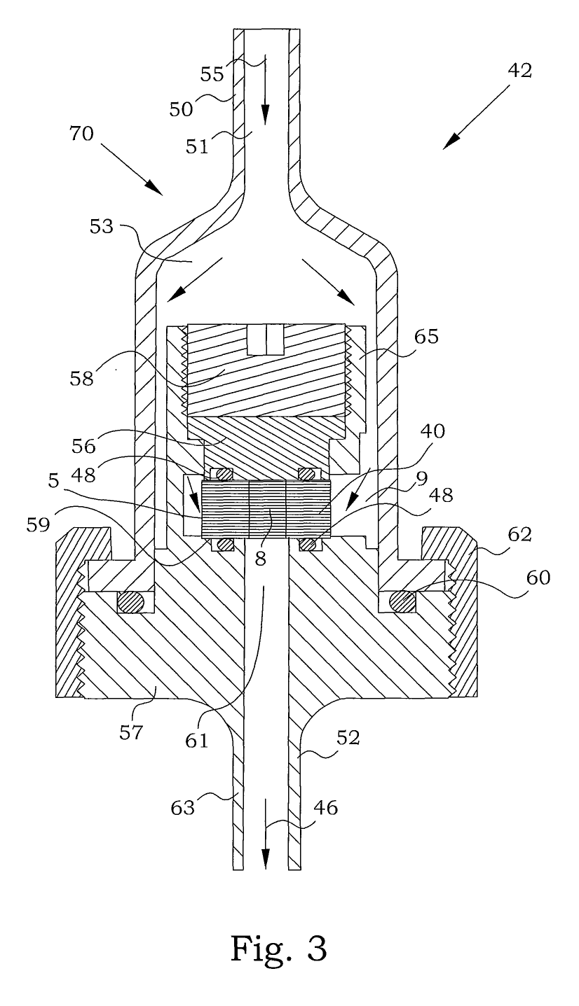

In operation, the filter comprising the stack of wafers is comprised in a filter assembly. Such filter assembly can be designed in many ways and is typically adapted to the particular application. One embodiment of a filter assembly 42 is illustrated in FIG. 3 in a cross-sectional view. The filter assembly 42 comprises a filter housing 70 having an inlet piece 50 and an outlet piece 52. The inlet piece 50 is mounted against the outlet piece 52 with a threaded case 62 and sealed against each other with a sealing 60. The inlet piece 50 comprises a pipe 51 which downstream is widened into a cup 53. The fluid to be filtered enters through the pipe 51, as illustrated by the arrow 55 and flow into the cup 53. The outlet piece 52 comprises a cylinder part 57 presenting a filter support 59 at its upstream part. A bore 61 is provided in the middle of the cylinder part 57, which bore 61 continues into a pipe 63. The fluid that has been filtered exits through the bore 61 as indicated by the arrow 46.

A filter 40, comprising a stack of wafers, e.g. as been described above is fixed against the filter support 59 by means of a pressing cylinder 56. The pressing cylinder 56 is pressed against the filter by a threaded screw 58, which interacts with a threaded part of a holder portion 65 attached to the cylinder part 57. The filter 40 is sealed against the filter support 59 and the pressing cylinder 56 by means of 0-rings 48. By this sealing, there is no fluid contact between a volume 9 outside the filter in a radial direction and the internal tube 8 of the filter except through the filter channels. In other words, a sealing, in this embodiment the O-rings 48 separates a volume 9 that is in contact with the outer rim 5 of the stack of wafers from a volume that is in contact with the internal tube 8. The screw 58, the holder portion 65, the pressing cylinder 56 and the filter 40 are contained within the cup 53 of the inlet piece 50. The holder portion 65 has openings allowing fluid flowing into the interior of the cup 53 to reach the outer rim 5 of the filter 40.

In the present embodiment, the filter assembly is intended to operate with a fluid flow from the inlet piece to the outlet piece. In other words, an inlet of fluid is connected to the volume 9 that is in contact with the outer rim 5 of the stack of wafers and an outlet of fluid is connected to the volume that is in contact with the internal tube 8.

However, in alternative embodiments, the opposite flow direction through the filter can also be utilized. In other words, an outlet may be connected to the volume 9 that is in contact with the outer rim 5 of the stack of wafers and an inlet may be connected to the volume that is in contact with the internal tube 8. This can simply be realised by just change the intended flow direction in FIG. 3.

Anyone skilled in the art realizes that the detailed design of the filter assembly can be varied and modified in many ways. The basic principle is, however, to provide a sealing that separates the fluid volume outside the outer rim 5 of the stack 34 from the fluid volume in contact with the internal tube 8.

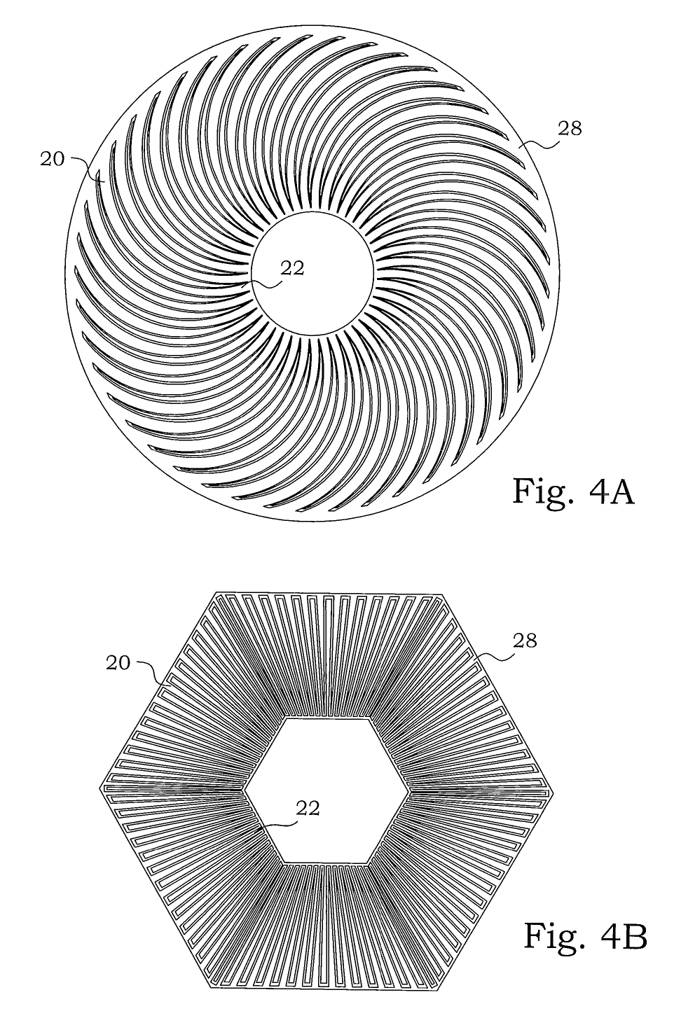

Also the design of the arrangement of filter channels can be varied in many ways. FIG. 4A illustrates an embodiment of wafer 28 with first coarse filter channels 20 and second coarse filter channels 22 according to another design. In this embodiment the first coarse filter channels 20 and second coarse filter channels 22 are slightly bent. The length of the first coarse filter channels 20 and second coarse filter channels 22 thereby becomes somewhat larger than in previous embodiments, however, they typically have to be provided at longer distances from each other. The fine filter channels are not shown in this view, since they are intended to be provided in the wafer surface being held against this surface. The fine filter channels intended for this particular embodiment comprises six channels that slowly spiral out from the inner edge turn after turn.

In FIG. 4B another embodiment of a wafer 28 with first coarse filter channels 20 and second coarse filter channels 22 according to the present invention is illustrated. In this embodiment, the wafer 28 has a hexagonal shape. Also the hole 6 in the centre of the wafer 28 is hexagonal. The first coarse filter channels 20 and second coarse filter channels 22 are provided in a fan-shaped pattern in each sector of the wafer. The fine filter channels (provided for in an opposite surface) are in the shape of congruent hexagons. The alignment of such wafers is facilitated by the outer shape.

In FIG. 4C another embodiment of a wafer 28 according to the present invention is illustrated. In the specific application intended for this embodiment, the hole 6 creating the internal tube 8 was requested to be situated offset from a central position at the wafer 28. The first coarse filter channels 20 and second coarse filter channels 22 were arranged in parallel linear sections, where some coarse filter channels merge into common sections to utilize the wafer surface as efficient as possible.

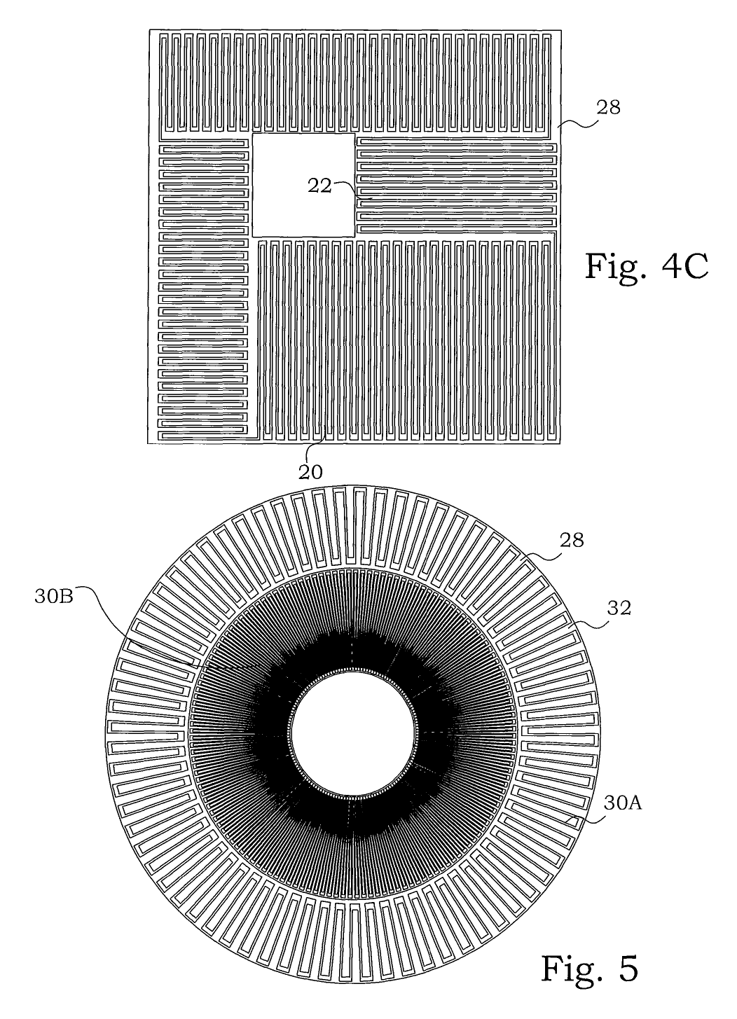

In the embodiments described so far, the first coarse filter channels and the second coarse filter channels extend, typically radially, over a majority of the distance between the outer rim of the stack of wafers and the hole. However, there are also other possibilities. In some applications, it may be requested that the fluid is filtered in two stages; a first coarse stage that can take care of a majority of the particles and a fine stage which is responsible for the final filtering. This can easily be accomplished by embodiment of the present invention. In FIG. 5, a wafer 28 is illustrated, at which two arrangements of filter channels 30A, 30B are provided. A first arrangement of filter channel is 30A arranged radially outside of a second arrangement of filter channels 30B. In the first arrangement of filter channels 30A, the first coarse filter channels and the second coarse filter channels are broad and the fine filter channels have also a relatively large cross-section area. In this part of the filter the large particles are trapped. However, since the channels through which the fluid is flowing are relatively wide, the pressure drop becomes small even if many of the fine filter channels are blocked by trapped particles. In the second arrangement of filter channels 30B, the first coarse filter channels and the second coarse filter channels are narrower and are also separated by thinner ridges. The fine filter channels are here very narrow, in order to perform a final filtering of the fluid. Such a tandem filtering action is thus provided at each interface in a stack of wafers and the tandem filter can thus be exchanged for a single filter without any further modifications of the filter housing.

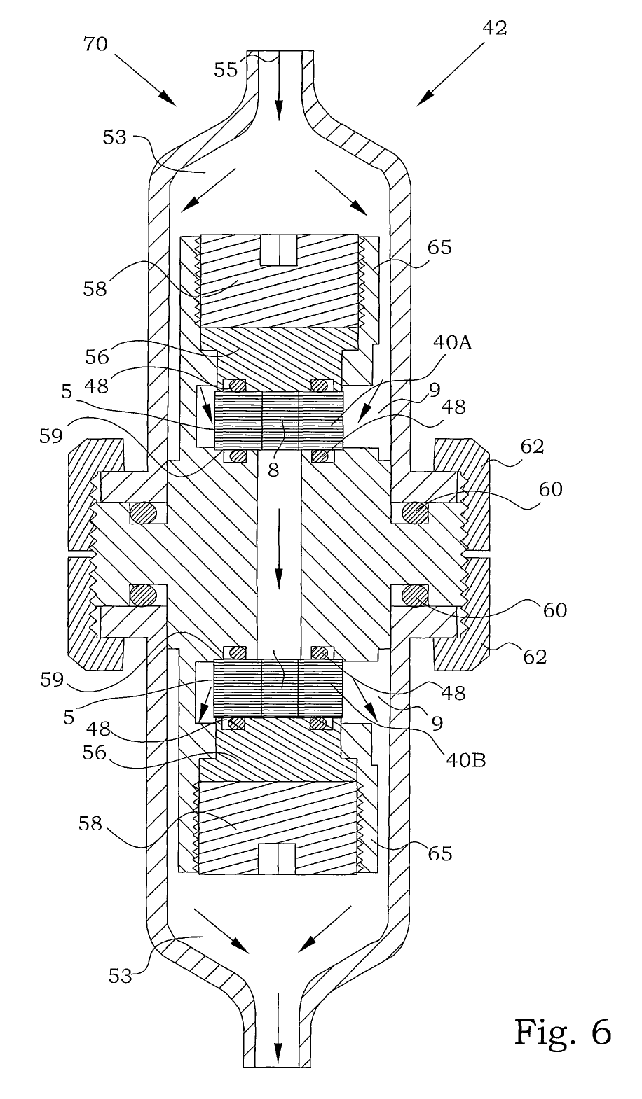

A tandem filtering can also be achieved by providing two stacks of wafers connected in series. FIG. 6 illustrates one embodiment of such a filter arrangement. A first filter 40A filters fluid streaming from the outer rim 5 of the wafer stack into the internal tube 8. This internal tube 8 of the first filter 40A is in the present embodiment in fluid connection with the internal tube of the second filter 40B. A second filtering can thereby be provided for fluid streaming from the internal tube 8 to the outer rim of second filter 40B. The first filter 40A can then be selected to be a coarse filter and the second filter 40B can be selected to be a fine filter.

In alternative embodiments, the two filters can of course be connected in series in other configurations, e.g. having both filters operating in the same direction through the wafer interfaces or having the coarse filter operating with a stream direction radially outwards, while the fine filter operates with a stream direction radially inwards.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-13. (canceled)

14. Filter, comprising:
a stack of wafers;
each of said wafers having a through hole;
edges of said holes of said wafers in said stack together defining an internal tube;
at least one interface between adjacent said wafers defining an arrangement of filter channels;
said arrangement of filter channels comprising first coarse filter channels, second coarse filter channels, and fine filter channels;
said first coarse filter channels being open towards an outer rim of said stack of wafers, extending in a direction from said outer rim towards said internal tube and being closed towards said internal tube;
said second coarse filter channels being open towards said internal tube, extending in a direction from said internal tube towards said outer rim of said stack of wafers and being closed towards said outer rim of said stack of wafers;
said fine filter channels connecting said first coarse filter channels and said second coarse filter channels;
said first coarse filter channels and second coarse filter channels extend substantially radially with respect to said hole and in that said fine filter channels extend substantially tangentially with respect to said hole;
said first coarse filter channels and said second coarse filter channels are defined by recesses in a surface of a first wafer defining said at least one interface and said fine filter channels are defined by recesses in a surface of a second wafer, opposite to said first wafer, defining said at least one interface;
said recesses in said surface of said second wafer defining said fine filter channels are continuous recesses, each one encircling said hole.

15. Filter according to claim 14, wherein said recesses defining said first coarse filter channels, said second coarse filter channels and said fine filter channels are produced by MicroElectroMechanical System - MEMS - techniques.

16. Filter according to claim 14, wherein each of said filter channels in said arrangement of filter channels being closed in a direction transverse to a main plane of said wafers.

17. Filter according to claim 14, wherein said surface of a wafer comprises a coating.

18. Filter according to claim 14, wherein said first coarse filter channels and said second coarse filter channels each have a cross-section area that is larger than the sum of the cross-section areas of fine filter channels connecting the respective first coarse filter channel or second coarse filter channel.

19. Filter according to claim 14, wherein said internal tube has a cross-section area that is larger than the sum of the cross-section areas of the second coarse filter channels.

20. Filter according to claim 14, wherein said fine filter channels are curved, prohibiting a line of sight between adjacent first coarse filter channels and second coarse filter channels.

21. Filter according to claim 14, wherein said first coarse filter channels and second coarse filter channels extend radially over a majority of the distance between said outer rim of said stack of wafers and said hole.

22. Filter according to claim 14, further comprising at least two said arrangements of filter channels arranged one radially inside another at at least one interface and arranged to filter a fluid in consecutive stages, one in each of said at least two arrangements of filter channels.

23. Filter assembly, comprising:
a filter housing;
a filter arranged in said filter housing;
said filter in turn comprising:
a stack of wafers;
each of said wafers having a through hole;
edges of said holes of said wafers in said stack together defining an internal tube;
at least one interface between adjacent said wafers defining an arrangement of filter channels;
said arrangement of filter channels comprising first coarse filter channels, second coarse filter channels, and fine filter channels;
said first coarse filter channels being open towards an outer rim of said stack of wafers, extending in a direction from said outer rim towards said internal tube and being closed towards said internal tube;
said second coarse filter channels being open towards said internal tube, extending in a direction from said internal tube towards said outer rim of said stack of wafers and being closed towards said outer rim of said stack of wafers;
said fine filter channels connecting said first coarse filter channels and said second coarse filter channels;
said first coarse filter channels and second coarse filter channels extend substantially radially with respect to said hole and in that said fine filter channels extend substantially tangentially with respect to said hole;
said first coarse filter channels and said second coarse filter channels are defined by recesses in a surface of a first wafer defining said at least one interface and said fine filter channels are defined by recesses in a surface of a second wafer, opposite to said first wafer, defining said at least one interface;
said recesses in said surface of said second wafer defining said fine filter channels are continuous recesses, each one encircling said hole; and
a sealing, separating a volume being in contact with said outer rim of said stack of wafers from a volume being in contact with said internal tube.

24. Filter assembly according to claim 23, further comprising an inlet piece connected to said volume being in contact with said outer rim of said stack of wafers and an outlet piece being connected to said volume being in contact with said internal tube.

25. Filter assembly according to claim 24, further comprising an outlet piece connected to said volume being in contact with said outer rim of said stack of wafers and an inlet piece being connected to said volume being in contact with said internal tube.

26. Filter assembly according to claim 23, comprising at least two said filters arranged in said filter housing connected in series.

27. Filter according to claim 15, wherein each of said filter channels in said arrangement of filter channels being closed in a direction transverse to a main plane of said wafers.

28. Filter according to claim 15, wherein said surface of a wafer comprises a coating.

29. Filter according to claim 16, wherein said surface of a wafer comprises a coating.

30. Filter according to claim 27, wherein said surface of a wafer comprises a coating.

31. Filter according to claim 15, wherein said first coarse filter channels and said second coarse filter channels each have a cross-section area that is larger than the sum of the cross-section areas of fine filter channels connecting the respective first coarse filter channel or second coarse filter channel.

32. Filter according to claim 16, wherein said first coarse filter channels and said second coarse filter channels each have a cross-section area that is larger than the sum of the cross-section areas of fine filter channels connecting the respective first coarse filter channel or second coarse filter channel.

33. Filter according to claim 17, wherein said first coarse filter channels and said second coarse filter channels each have a cross-section area that is larger than the sum of the cross-section areas of fine filter channels connecting the respective first coarse filter channel or second coarse filter channel.
